(19) United States
(12) Patent Application Publication
(10) Pub. No.: US 2014/0058664 A1
(43) Pub. Date: Feb. 27, 2014

(54) Vehicle locator system

(71) Applicant: Sung Bong Kim, Niles, IL (US)

(72) Inventor: Sung Bong Kim, Niles, IL (US)

(21) Appl. No.: 13/953,596

(22) Filed: Jul. 29, 2013

Related U.S. Application Data
(60) Provisional application No. 61/693,697, filed on Aug. 27, 2012.

(51) Int. Cl. G01C 21/30

(52) U.S. Cl. CPC G01C 21/30
USPC 701/431

(57) ABSTRACT

A vehicle locator system comprising: a remote keyless entry transmitter for vehicles (key fob) having a rechargeable battery, a timer, a GPS/RF locator circuit, a first, second and third button and a display window. When the key fob is inserted in the key hole or in the base cradle of the vehicle, the vehicle's main battery charges the rechargeable battery. The first button, when pressed, unlocks the vehicle at the same time it turns on the GPS/RF connection. The second button, when pressed, locks the vehicle and records the location of the vehicle. The timer maintains the GPS/RF circuit on for a predetermined period of time. The third button, when pressed, shows the location of the vehicle almost immediately on the display window of the key fob by showing the address of the location alongwith direction and the distance to the vehicle.

This application claims the benefit of U.S. Provisional application 61/693,697, filed Aug. 27, 2012.

### FIELD OF THE INVENTION

The present invention relates to means to locate a vehicle using RF and/or Global Positioning System technology and a remote keyless entry transmitter for vehicles.

### BACKGROUND OF THE INVENTION

It is not uncommon in our daily lives to see people in a vast parking lot who have forgotten where they left their car and pace back and forth in frustration. Also, there are occasions when parents or car owners need to find out where their cars are. To address these needs, a number of systems are developed for the vehicle owners to locate their car using RF and/or Global Positioning System technology. Some of these devices are commercially available by a number of companies.

Although they are generally useful, their usage has been limited due to a number of reasons. First, people have to carry an extra bulky object in their pockets. Secondly, when they turn the device on to locate their vehicles, it takes longer than desired for the GPS device to find satellites and lock in before the device is able to show the location of the vehicle, rendering it unacceptable. The purpose of this invention is to integrate such a device into a conventional remote keyless entry transmitter for vehicles that will show the location of the vehicle almost instantly when the device is activated to do so.

### SUMMARY OF THE INVENTION

The present invention is generally directed to a vehicle locator system. A first GPS and/or RF circuitry is installed anywhere in the car, preferably in a hidden place to keep it from being hampered. A cylindrical container is secured on the starter lock cylinder of the vehicle, and contains a battery charging circuitry. The main battery of the vehicle provides power to said battery charging circuitry and the first GPS and/or RF circuitry. The first GPS and/or RF circuitry constantly transmits signal(s) that can be traced back to reveal the vehicle's location in a conventional manner. The remote keyless entry transmitter for vehicles, hereinafter referred to as “the fob”, contains a rechargeable battery, a microprocessor, a timer and a second GPS and/or RF circuitry with a display window on one side and all the conventional door related buttons on the other side. The rechargeable battery provides power to all the circuitry in the fob including the second RF and/or GPS circuitry. When the fob is placed in the final position to start the vehicle for driving, or the engine starter key is fully inserted into the key hole, electric contacts are established and said battery charging circuitry charges continuously the rechargeable battery in the fob. Therefore, the rechargeable battery in the fob stays fully charged most of the time. When the “UNLOCK” button on the fob is pressed to open the car door, it also turns on the second RF and/or GPS circuitry in the fob, which starts searching for the satellites and, upon finding them, maintains the contact with the satellites. When the fob is removed from the vehicle and the “LOCK” button on the fob is pressed to park the vehicle, it also starts the timer in the fob. After a predetermined period of time, the timer turns off the second RF and/or GPS circuitry in the fob. During this predetermined period of time, preferably long enough time for the driver to finish his or her business such as shopping and return to the car, the almost fully charged rechargeable battery in the fob enables the second GPS circuitry to stay in contact with the satellites. With the first RF and/or GPS circuitry in the vehicle continuously transmitting the RF and/or GPS signal revealing the location of the vehicle, and the second RF receiver circuitry in the fob staying active and/or the GPS circuitry staying locked in with the satellites, the microprocessor in the fob readily calculates the location of the vehicle in the conventional manner when the “FIND” button is pressed, and displays it almost instantly on the fob.

It shows the vehicle's location on the display window of the fob by the combination of an arrow pointing in the direction of the vehicle and a numerical display of the distance to it. When GPS technology is used, it also shows on the display window, the street address of the vehicle's location whenever it is possible to do so.

### BRIEF DESCRIPTION OF THE DRAWINGS

FIG. 1 is an isometric exploded view of a starter lock cylinder assembly and a conventional fob without the present invention.

FIG. 2 is a cross sectional view of FIG. 1 along the line 2-2 of FIG. 7.

FIG. 3 is an isometric exploded view of a starter lock cylinder assembly and a fob with the present invention.

FIG. 4 is a cross sectional view of FIG. 3 along the line 4-4 of FIG. 7.

FIG. 5 is a cross sectional view of FIG. 3 along the line 5-5 of FIG. 7 with the fob inserted in the opposite way from the way shown in FIG. 4.

FIG. 6 shows the starter key hole with the present invention.

FIG. 7 shows the starter key hole with the fob inserted.

FIG. 8 is a partial exploded view of the fob showing the electric contacts to the battery charging circuitry.

### DETAILED DESCRIPTION OF THE PREFERRED EMBODIMENT

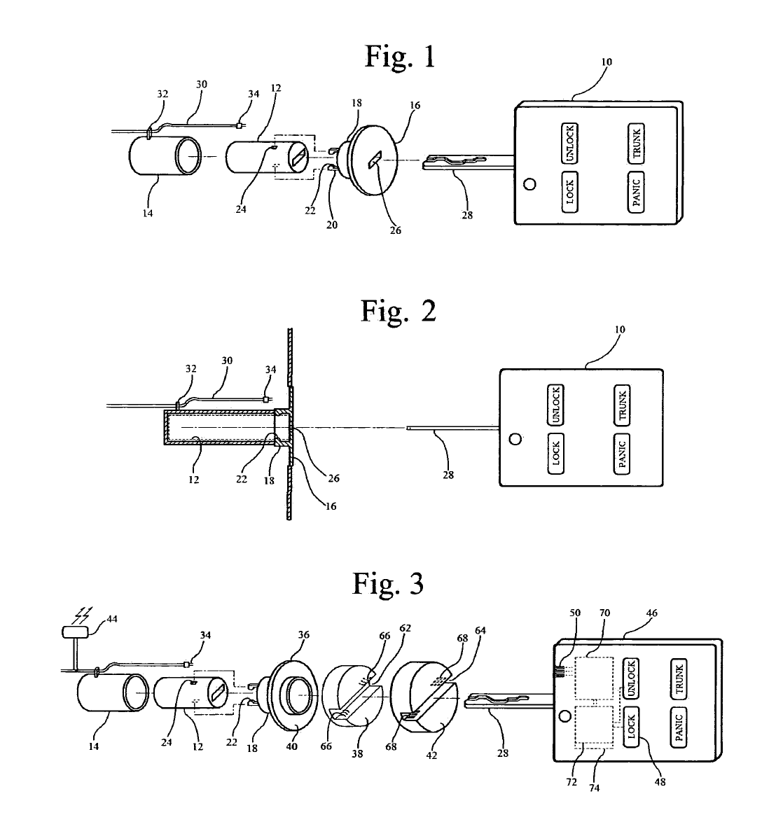

The present invention can be standard for a vehicle or it can be an option available only to those who would be willing to pay for it. A preferred design of the conventional starter lock and a matching fob is shown in FIG. 1 and FIG. 2 with the fob shown with the designated reference number 10. The starter lock cylinder 12 is inserted and rotatably secured in the cylinder housing 14 in conventional manner.

The disc surface 16 has a cylindrical extension 18, which has two further linear extensions 20 with raised bumps 22 at their tail ends. The disc surface 16 is made of reasonably elastic material such as plastic. The starter lock cylinder 12 has two recessed slots 24. As shown in FIG. 1 and FIG. 2, the starter lock cylinder 12 is inserted into the cylindrical extension 18. The disc surface 16 is then rotated until the raised bumps 22 clicks into the recessed slots 24. The disc surface 16 has a key hole 26 through which the starter key 28 is inserted. Two power supply lines 30 from the main battery of the vehicle (not shown) is secured at the anchor 32 and has two connector pins 34 at their ends for later use with the implementation of the present invention.

When it is desired, the disc surface 16 can be pried out from the starter lock cylinder 12 and, as shown in FIG. 3, a new disc surface 36 with the present invention can be installed in the same manner as before. When the starter lock cylinder 12 rotates, the disc surface 36 rotates with it.

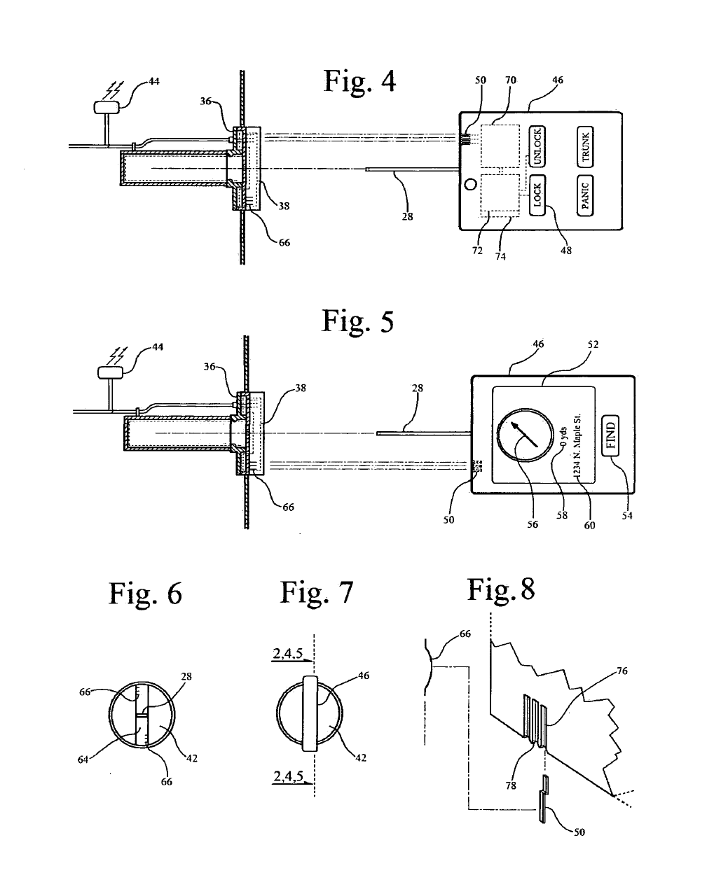

A battery charging circuitry 38 is embedded on the base surface 40 of the disc surface 36. A housing 42 is pressure fit on the disc surface 36 over the battery charging circuitry 38. As shown in FIG. 4 and FIG. 5, the connector pins 34 from the main battery of the vehicle is now plugged into the battery charging circuitry 38 and provides power to the battery charging circuitry 38. As shown in FIG. 3, FIG. 4 and FIG. 5, a first GPS and/or RF circuitry 44, powered by the main battery of the vehicle, is provided somewhere in the vehicle well hidden where it wouldn't be easily hampered and continuously transmits GPS and/or RF signal(s).

As shown in FIG. 3 and FIG. 4, one side of the fob 46 has all the conventional door related buttons 48 and a set of connector pins 50. As shown in FIG. 5, the other side of the fob 46 has a display window 52 and a “FIND” button 54. When pressed, the “FIND” button 54 turns on the display window 52 with an arrow 56 and a numerical display 58 showing the direction and the distance to the vehicle, along with the street address 60 of the location of the vehicle in the manner that will be described later.

As shown in FIG. 3 and FIG. 6, the battery charging circuitry 38 and the housing 42 has recessed grooves 62 and 64 respectively to receive the fob 46. The output of the battery charging circuitry 38 is split into two sets of spring type contact points 66 in the inner side walls of the recessed groove 64 and extends through the rectangular openings 68 of the housing 42. As shown in FIG. 4 and FIG. 5, when the fob 46 is fully inserted into the recessed groove 64 for driving, the set of the contacts 50 comes in contact with one of the contact point sets 66 depending on which way the fob 46 is turned and inserted into the recessed groove 64. The battery charging circuitry 38 then starts charging the rechargeable battery 70 and keeps it fully charged most of the time. The rechargeable battery 70 provides power to all the circuitry in the fob 46 including the second RF and/or GPS circuitry 72. When the “UNLOCK” button on the fob 46 is pressed to open the car door, it also turns on the second RF and/or GPS circuitry 72 in the fob, which starts searching for the satellites and, upon finding them, locks in with the satellites in conventional manner.

When the fob 46 is removed from the vehicle and the “LOCK” button on the fob is pressed to park the vehicle, it also starts a timer 74. After a predetermined period of time, the timer 74 turns off the second RF and/or GPS circuitry 72 in the fob 46. During this predetermined period of time, the fully charged rechargeable battery 70 enables the second GPS circuitry 72 in the fob to stay in contact with the satellites, preferably long enough for the driver to finish his or her business, such as shopping, and return to the vehicle. With the first RF and/or GPS circuitry 44 in the vehicle continuously transmitting the RF and/or GPS signal revealing the location of the vehicle and the second RF and/or GPS receiver circuitry 72 in the fob staying active and/or staying locked in with the satellites, the microprocessor (not shown) in the fob 46 readily calculates the location of the vehicle in conventional manner when the “FIND” button 54 on the fob is pressed and displays it almost instantly on the display window 52.

It shows the vehicle's location on the display window 52 by the combination of an arrow 56 pointing in the direction of the vehicle and a numerical display 58 of the distance to it. When GPS technology is used, the display window also shows the street address 60 of the vehicle's location in conventional manner whenever it is possible to do so.

Another function of the “FIND” button 54 is, when pressed, to produce a signal to turn on the second RF and/or GPS circuitry 72. If the second RF and/or GPS circuitry 72 was already on because of the timer 74, this signal will be ignored. However, if the predetermined time has expired and the second RF and/or GPS circuitry 72 was turned off, the “FIND” button 54 turns on the second RF and/or GPS circuitry 72 which will start looking for the satellites. Upon finding them, the location of the vehicle will be calculated in a conventional manner with the information transmitted by the first RF and/or GPS circuitry from the vehicle and displayed on the fob in the same way as described above. It should be noted that the owner can find the location of the vehicle in either case. The only difference is that it will take a longer time in the latter case for the fob to display the vehicle's location.

As shown in FIG. 8, the contact points 50 are secured in the recessed grooves 76 to eliminate chance of accidental shortage by metallic objects. The recessed grooves 76 has guide openings 78 to guide the spring contacts 66 into the recessed grooves 76 to come in contact with the contact points 50.

While the invention is described in connection with what is presently considered the most practical and preferred embodiment, it is to be understood that the invention is not to be limited to the disclosed embodiments, but on the contrary, is intended to cover various modifications and equivalent arrangements included within the spirit and scope of the appended claims.

What is claimed is:

1. A vehicle locator system comprising:
a first RF and/or GPS circuitry powered by the main battery of the vehicle and continuously transmitting RF and/or GPS signal that can be traced back in conventional manner to reveal the location of the vehicle; and
a remote keyless entry transmitter for vehicles having, a rechargeable battery with a set of contact points for power input, a second RF and/or GPS circuitry, a microprocessor, a timer, a display window, a first button that, when pressed, opens the door of the vehicle at the same time it turns on said second RF and/or GPS circuitry, a second button that, when pressed, locks the doors of the vehicle at the same time it turns on said timer that will turn off said second RF and/or GPS circuitry after a predetermined period of time; a third button that, when pressed, commands said microprocessor to produce a signal to turn on said second RF and/or GPS circuitry at the same time it starts calculating the location of the vehicle in conventional manner using the information from said first RF and/or GPS circuitry and said second RF and/or GPS circuitry and displays it on said display window and;
a housing having a battery charging circuitry that is powered by the main battery of the vehicle and having output contact points split into two different sets, one of which comes in contact with said set of contact points of said rechargeable battery of said remote keyless entry transmitter when said remote keyless entry transmitter is placed in final position to start the vehicle; and

2. A vehicle locator system of claim 1, said display window displays the location of the vehicle by the combination of an arrow showing the direction and a numerical display of the distance to the location of the vehicle at the same time it shows the street address of the location whenever it is possible to do so.

3. A vehicle locator system of claim 1, said housing having reasonably elastic linear extensions from its base surface with raised bumps at their tail ends.

4. A vehicle locator system of claim 3, the starter lock cylinder has recessed slots to receive said raised bumps.
